(19) United States
(12) Patent Application Publication
(10) Pub. No.: US 2019/0209954 A1
(43) Pub. Date: Jul. 11, 2019

(54) IMPROVED ROOM AIR PURIFIERS AND FILTRATION MEDIA

(71) Applicant: 3M INNOVATIVE PROPERTIES COMPANY, St. paul, MN (US)

(72) Inventors: Andrew R. Fox, Oakdale, MN (US); Himanshu Jasuja, St. Paul, MN (US); Bryan L. Gerhardt, Woodbury, MN (US); Dennis M. Glass, Cottage Grove, MN (US)

(21) Appl. No.: 16/328,401

(22) PCT Filed: Aug. 22, 2017
(86) PCT No.: PCT/US2017/048019

§ 371 Date: Feb. 26, 2019

Related U.S. Application Data
(60) Provisional application No. 62/379,772, filed on Aug. 26, 2016.

(51) Int. Cl. B01D 39/16; B01D 46/00; B01D 46/52; B01D 53/04; B32B 5/02; B32B 5/16; B32B 5/26; B32B 5/30; B01J 20/20; B01J 20/28

(52) U.S. Cl. CPC B01D 39/163; B32B 2307/724; B01D 46/0036; B01D 46/521; B01D 53/04; B32B 5/022; B32B 5/16; B32B 5/26; B32B 5/30; B01J 20/20; B01J 20/28016; B01J 20/2803; B01J 20/28035; B01J 20/28052; B01D 2239/0407; B01D 2239/0435; B01D 2239/0464; B01D 2239/0618; B01D 2239/0627; B01D 2239/0654; B01D 2239/1275; B01D 2239/1258; B01D 2239/1216; B01D 2275/10; B01D 2279/50; B01D 2253/102; B01D 2257/708; B01D 2259/4508; B01D 2239/0622; B32B 2250/03; B32B 2260/025; B32B 2262/0253; B32B 2264/108; B32B 2262/0215; B01D 46/0032

(57) ABSTRACT

The present disclosure relates generally to improved room air purifiers and filtration media for use in room air purifiers. In some embodiments, the room air purifiers and media exhibit excellent filtration of cigarette smoke and/or formaldehyde. Some embodiments include a multilayer filtration media, comprising: a fluorinated electret layer; a sorbent layer adjacent to the fluorinated electret layer; and an optional backing layer having a Gurley stiffness of at least about 200 mg; where the backing layer is not present, at least one of the fluorinated electret layer, the sorbent layer, or the combination of the two layers has a Gurley stiffness of at least about 200 mg. In some embodiments, the filtration media is pleated.

### TECHNICAL FIELD

The present disclosure relates generally to improved room air purifiers and filtration media for use in room air purifiers. In some embodiments, the room air purifiers and media exhibit excellent filtration of cigarette smoke and/or formaldehyde.

### BACKGROUND

Indoor air pollution has two major categories of pollutants: particulate and gaseous. Particulate matter, or PM, refers to particles found in the air, including, for example, dust, dirt, soot, smoke, and liquid droplets. PM can come in many different sizes. Some particles are large or dark enough, at a high enough concentration, to be seen such as, for example, as soot or smoke. Other particles are so small that individually they can only be detected with an electron microscope. Particles less than 10 micrometers in diameter (PM₁₀) pose a health concern because they can be inhaled into and accumulate in the respiratory system. Particles less than 2.5 micrometers in diameter (PM2.5) are referred to as “fine” particles and are believed to pose the greatest health risks. Because of their small size (approximately 1/30th the average width of a human hair), these fine particles can lodge deeply into the lungs. PM_{2.5} is generally filtered from the air using nonwoven media-based filters, frequently where the filter media has been treated with an electrostatic charge to enhance the fine particle removal. Exemplary patents describing filter media treated with an electrostatic charge to enhance fine particle removal include, for example, U.S. Pat. No. 6,397,458.

Cigarette smoke produces small particulate matter that can cause health concerns. This particulate matter can be challenging to remove because it is quite oily. Filtration media including fluorinated materials or fluorochemical melt additives show excellent removal of oily particulate matter. Filtration media capable of removing oily particulate matter is described in, for example, U.S. Pat. Nos. 5,411,576, 5,472,481, 6,288,157, 6,068,799, 6,214,094, 6,238,466, and 6,261,342.

One class of notable gaseous pollutants are volatile organic compounds (“VOCs”). These are generally organic chemicals that are gaseous at room temperature. One notable class of VOCs is aldehydes, one of which is formaldehyde. Formaldehyde is in many household products. For example, formaldehyde is often used in clothing and drapes to create a permanent press. It is also used in adhesives, and in some paints and coating products. According to the E.P.A., formaldehyde is most concentrated in particleboard, plywood paneling, and medium density fiberboard. Exposure to formaldehyde has several health consequences. It can cause watery eyes, burning sensations in the eyes and throat, and difficulty breathing. At its most extreme, it can cause severe wheezing and coughing, allergic reactions and perhaps even cancer.

Filters and filter media that remove VOC's from the air often include activated carbon material. However, due to its low molecular weight, formaldehyde is a VOC that is particularly difficult to capture. One exemplary filter media has been designed to remove formaldehyde includes activated carbon that has been chemically treated with functionalities or sorbents that react with formaldehyde. One exemplary patent describing filter media capable of capturing formaldehyde includes Chinese Patent No. 2015-202366934 entitled FRAMED, PLEATED AIR FILTER COMPRISING PLEATED AIR FILTER MEDIA WITH THREE LAYERS, assigned to the present assignee. One exemplary patent application describing filter media capable of removing aldehydes from the air is US 20040163540.

A significantly revised China national standard for testing and rating room air purifier performance, GB/T 18801-2015, was published in late 2015 and went into effect Mar. 1, 2016. The standard includes a Clean Air Delivery Rate (CADR) for particulates, toluene (a typical VOC), and formaldehyde. CADR is a measure of the total air cleaning performance of a room air purifier device, including both fan and filter performance, and it is reported in units of volume flow, for example m³/hr. The 2015 standard also includes a new service life test for both particulates and formaldehyde, called CCM, or cumulate clean mass. Simply put, this test measures the quantity of the particular pollutant that can be captured when the device performance (CADR) has dropped to 50% of the starting value. The CCM is measured in milligrams of pollutant captured, and it is reported on a discrete scale with levels from 1-4, with 4 being the highest grade. Particulate CCM is identified on a scale ranging from P1-P4, and formaldehyde CCM is identified on a scale ranging from F1-F4. The minimum particulate CCM to reach the top rating, P4, is 12,000 mg. The minimum formaldehyde CCM to reach the top rating, F4, is 1500 mg.

One type of filtration media attempting to meet GB/T 18801-2015 test includes multi-layer media, pleated “combination” type filter structures. These combination filters typically use a three-layer construction to provide a pleated structure with both particulate and gaseous contaminant removal abilities. The first layer is typically a stiff, low pressure drop backing to provide good pleating performance—often a well-bonded staple fiber (e.g., carded or airlaid) or spunbond web. The middle layer is a sorbent layer, with a mixture of adhesive and impregnated activated carbon. The top layer is typically an electrostatically charged meltblown media. Optionally, a cover layer may be placed on top of the meltblown layer.

### SUMMARY

The inventors of the present disclosure recognized a need for room air purifiers and media for use in room air purifiers that are capable of providing excellent formaldehyde removal and excellent performance and service life when exposed to cigarette smoke. The inventors of the present disclosure also recognized that the existing attempts to create filter media that meets GB/T 18801-2015 have various disadvantages. For example, the inventors of the present disclosure recognized that in these constructions, the toluene and formaldehyde performance is exclusively determined by the sorbent layer, while the particulate performance is largely controlled by the particulate filter layer (e.g., meltblown). For both particulate and gaseous performance, a general rule of thumb is that the media CCM per area is fairly stable, and the filter CCM equals the product of the media CCM and the media area. Thus, more media area typically gives a greater CCM for both particulate and formaldehyde. It is also generally known that high pressure, fine fiber type meltblown nonwovens can provide a high particle CCM per unit area, but the high pressure drop also restricts airflow and reduces the total air cleaning rate (CADR). Further, high performing combination media type filters are expensive, so there is a disincentive to add media area to the filter. Combination media also tend to be thicker, sometimes significantly, compared to sorbent-free filter media. The thickness limits the maximum acceptable pleating density, because when the pleats become excessively close, they begin to block the airflow and cause a rise in filter airflow resistance. Therefore, the inventors of the present disclosure found a significant need for filter media which can provide high particle CCM per unit area, while at the same time providing a low airflow resistance.

The inventors of the present disclosure discovered that forming pleated filter media including a fluorinated electret layer, a sorbent layer, and an optional backing layer can achieve a new set of performance characteristics that are unmatched by other filtration media. The high initial quality factor of the media provides for high efficiency and low air flow resistance, resulting in good particle CADR. The oily resistance of the fluorinated fiber surface provides a significant extension, (e.g., 2× or greater) of the particle CCM according to the GB/T 18801-2015 test method compared to a standard fibrous filtration layer of similar pressure drop. The filter media exhibits excellent formaldehyde removal (CADR) and capacity (CCM). Further, when the filter media is used in a room air purifier, it is capable of providing a room air purifier filter with less than one square meter of nominal media usage, reducing cost and making this important product available to more people seeking cleaner air. “Nominal media usage” is the media usage calculated by the outside filter frame dimensions (ignoring any additional filter width which may be imparted by a foam or gasket or the like). The nominal media usage is often several percent higher than the true media usage.

Some embodiments relate to a multilayer filtration media, comprising: a fluorinated electret layer; a sorbent layer adjacent to the fluorinated electret layer; and an optional backing layer having a Gurley stiffness of at least about 200 mg; wherein the filter media is pleated; and where if the backing layer is not present, at least one of the fluorinated electret layer, the sorbent layer, or the combination of the two layers has a Gurley stiffness of at least about 200 mg.

In some embodiments, the multilayer filtration media further includes a backing layer adjacent to the sorbent layer, wherein the backing layer has a Gurley stiffness of at least about 200 mg. In some embodiments, the backing layer is a meltspun web or a staple-fiber web. In some embodiments, the backing layer includes one or more polyolefins, polyesters, and/or nylons. In some embodiments, the multilayer filtration media has a pressure drop of less than 15 mm H₂O at 14 cm/s test velocity.

Some embodiments relate to a pleated filter formed from the multilayer filtration media having a pressure drop of less than 150 Pa at a nominal face velocity of 1.1 m/s. Some embodiments relate to a pleated filter formed from the multilayer filtration media having a particle CCM of greater than 12,000 mg when tested according to GB/T 18801-2015. Some embodiments relate to a pleated filter formed from the multilayer filtration media having a particle CCM of greater than 12,000 mg/m² of nominal filter media when tested according to GB/T 18801-2015 and the CCM is normalized to the nominal filter media area. Some embodiments relate to a pleated filter formed from the multilayer filtration media having a particle CCM of greater than 300 cigarettes per square meter when tested according to the Media CCM Test.

Some embodiments relate to multilayer filtration media having an initial particle efficiency of greater than 90%. Some embodiments relate to multilayer filtration media in which the sorbent layer has about 100-500 grams of sorbent. Some embodiments relate to a multilayer filtration media in which the sorbent layer includes sorbent having a US mesh size range of 20 to 320. Some embodiments relate to a multilayer filtration media in which the sorbent layer includes activated carbon. Some embodiments relate to a multilayer filtration media in which the sorbent layer includes one or more chemically impregnated sorbents that provide formaldehyde removal. Some embodiments relate to a multilayer filtration media in which the sorbent layer includes one or more sorbents reactive to formaldehyde. Some embodiments relate to a multilayer filtration media in which the sorbent layer includes substantially continuous adhesive fibers that are bonded to the surface of sorbent particles. Some embodiments relate to a multilayer filtration media in which the sorbent layer includes alternating layers or adhesive and sorbent. Some embodiments relate to a multilayer filtration media in which the sorbent layer includes more than one layer of sorbent. Some embodiments relate to a multilayer filtration media in which the sorbent layer includes more than one type of sorbent. Some embodiments relate to a multilayer filtration media in which the fluorinated electret layer is a meltblown web or a meltspun web.

Some embodiments relate to a room air purifier including any of the multilayer filtration media embodiments described herein. In some embodiments, the room air purifier exhibits a particle CCM of P4 per the China National Standard. In some embodiments, the room air purifier exhibits a particle CCM of P4 per the China National Standard with less than 1.5 m² of filtration media. In some embodiments, the room air purifier exhibits a particle CCM of P4 per the China National Standard with less than 1.2 m² of filtration media. In some embodiments, the room air purifier exhibits a formaldehyde CCM of F4 per the China National Standard.

### BRIEF DESCRIPTION OF THE FIGURES

FIG. 1 is a graphical representation of cigarette smoke capacity and pressure drop characteristics of exemplary and comparative filtration media according to the present disclosure;

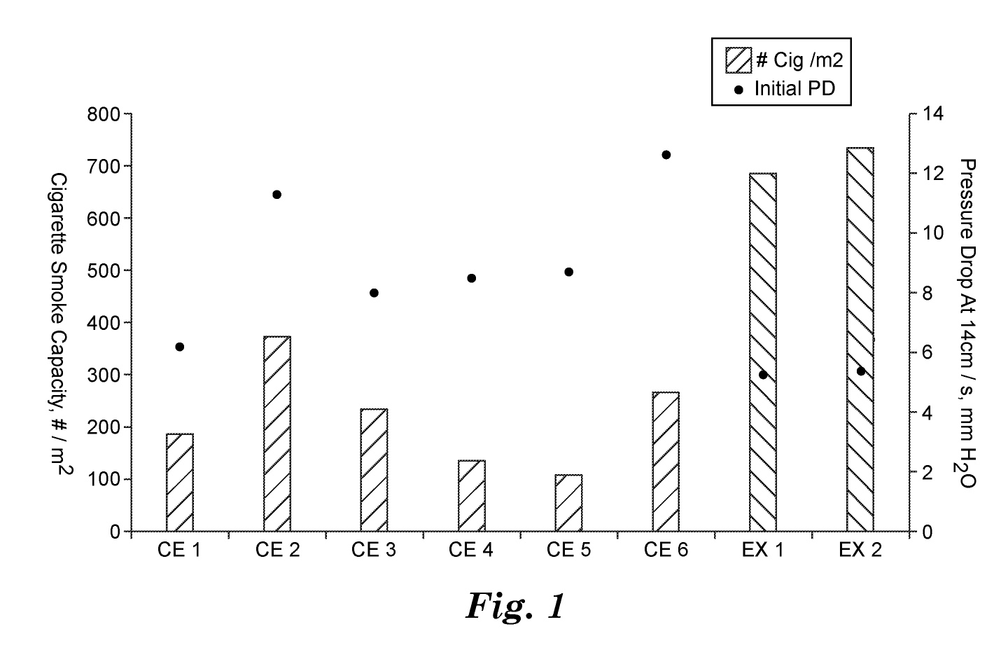

FIG. 2A is a graphical representation of particle CCM test results of exemplary and comparative filtration media according to the present disclosure;

FIG. 2B is a graphical representation of particle CCM test results, normalized for media area, of exemplary and comparative filtration media according to the present disclosure;

FIG. 3A is a graphical representations of formaldehyde CCM test results of exemplary and comparative filtration media according to the present disclosure; and

FIG. 3B is a graphical representation of formaldehyde CCM test results, normalized for media area, of exemplary and comparative filtration media according to the present disclosure.

### DETAILED DESCRIPTION

Filtration media of the present disclosure includes three layers: a fluorinated electret layer adjacent to a sorbent layer adjacent to a backing layer. In some embodiments, the filtration media is pleated. In some embodiments, the filtration media is used in room air purifiers.

In some embodiments, one or more of the above-described layers are in direct contact with one another such that no intervening layers are present. In other embodiments, one or more intervening layers are present between two or more of the layers described above.

In some embodiments, the multilayer filtration media has a pressure drop of less than 15 mm H₂O at 14 cm/s test velocity. In some embodiments, the multilayer filtration media has a pressure drop of less than 12 mm H₂O at 14 cm/s test velocity. In some embodiments, the multilayer filtration media has a pressure drop of less than 10 mm H₂O at 14 cm/s test velocity. In some embodiments, the multilayer filtration media has a pressure drop of less than 8 mm H₂O at 14 cm/s test velocity.

In some embodiments, the multilayer filtration media has an initial particle efficiency of greater than 90%. In some embodiments, the multilayer filtration media has an initial particle efficiency of greater than 95%. In some embodiments, the multilayer filtration media has an initial particle efficiency of greater than 98%. In some embodiments, the multilayer filtration media has an initial particle efficiency of greater than 99%.

In some embodiments, a pleated filter formed from the multilayer filtration media has a pressure drop of less than 150 Pa at a nominal face velocity of 1.1 m/s when tested at a nominal face velocity of 1.1 m/s. In some embodiments, a pleated filter formed from the multilayer filtration media has a pressure drop of less than 125 Pa at a nominal face velocity of 1.1 m/s when tested at a nominal face velocity of 1.1 m/s. In some embodiments, a pleated filter formed from the multilayer filtration media has a pressure drop of less than 100 Pa at a nominal face velocity of 1.1 m/s when tested at a nominal face velocity of 1.1 m/s. In some embodiments, a pleated filter formed from the multilayer filtration media has a pressure drop of less than 80 Pa at a nominal face velocity of 1.1 m/s when tested at a nominal face velocity of 1.1 m/s.

In some embodiments, a pleated filter formed from the multilayer filtration media has a particle CCM of greater than 12,000 mg when tested according to GB/T 18801-2015. In some embodiments, a pleated filter formed from the multilayer filtration media has a particle CCM of greater than 15,000 mg when tested according to GB/T 18801-2015. In some embodiments, a pleated filter formed from the multilayer filtration media has a particle CCM of greater than 20,000 mg when tested according to GB/T 18801-2015. In some embodiments, a pleated filter formed from the multilayer filtration media has a particle CCM of greater than 30,000 mg when tested according to GB/T 18801-2015. In some embodiments, a pleated filter formed from the multilayer filtration media has a particle CCM of greater than 40,000 mg when tested according to GB/T 18801-2015.

In some embodiments, the multilayer filtration media has a particle CCM of greater than 12,000 mg/m² of nominal filter media when tested according to GB/T 18801-2015 and the CCM normalized to the nominal filter media area. In some embodiments, the multilayer filtration media has a particle CCM of greater than 15,000 mg/m² of nominal filter media when tested according to GB/T 18801-2015 and the CCM normalized to the nominal filter media area. In some embodiments, the multilayer filtration media has a particle CCM of greater than 20,000 mg/m² of nominal filter media when tested according to GB/T 18801-2015 and the CCM normalized to the nominal filter media area. In some embodiments, the multilayer filtration media has a particle CCM of greater than 25,000 mg/m² of nominal filter media when tested according to GB/T 18801-2015 and the CCM normalized to the nominal filter media area. In some embodiments, the multilayer filtration media has a particle CCM of greater than 30,000 mg/m² of nominal filter media when tested according to GB/T 18801-2015 and the CCM normalized to the nominal filter media area. In some embodiments, the multilayer filtration media has a particle CCM of greater than 40,000 mg/m² of nominal filter media when tested according to GB/T 18801-2015 and the CCM normalized to the nominal filter media area.

In some embodiments, the multilayer filtration media has a particle CCM of greater than 300 cigarettes per square meter when tested according to the Media CCM Test described herein. In some embodiments, the multilayer filtration media has a particle CCM of greater than 400 cigarettes per square meter when tested according to the Media CCM Test described herein. In some embodiments, the multilayer filtration media has a particle CCM of greater than 500 cigarettes per square meter when tested according to the Media CCM Test described herein. In some embodiments, the multilayer filtration media has a particle CCM of greater than 700 cigarettes per square meter when tested according to the Media CCM Test described herein.

In some embodiments, the multilayer web or construction has a thickness of between about 1.5 mm and about 3.5 mm.

### The Fluorinated Electret Layer

The fluorinated electret layer can be of the type, include the materials described in, and/or be made using the processes described in any of the following patents, all of which are incorporated by reference in their entirety: U.S. Pat. Nos. 5,411,576, 5,472,481, 6,288,157, 6,068,799, 6,214,094, 6,238,466, 6,397,458, and 6,261,342.

In some embodiments, the electrets in the fluorinated electret layer can be prepared by fluorinating a polymeric article, optionally in the presence of a surface modifying electrical discharge, and charging the fluorinated article to produce an electret.

In some embodiments, the fluorination process includes modifying the surface of the polymeric article to contain fluorine atoms by exposing the polymeric article to an atmosphere that includes fluorine containing species. The fluorination process can be performed at atmospheric pressure or under reduced pressure. The fluorination process is preferably performed in a controlled atmosphere to prevent contaminants from interfering with the addition of fluorine atoms to the surface of the article. The atmosphere should be substantially free of oxygen and other contaminants. Preferably the atmosphere contains less than 0.1% oxygen.

In some embodiments, the fluorine containing species present in the atmosphere can be derived from fluorinated compounds that are gases at room temperature, become gases when heated, or are capable of being vaporized. Examples of useful sources of fluorine containing species include, fluorine atoms, elemental fluorine, fluorocarbons (e.g., C5 F12, C2 F6, CF4, and hexafluoropropylene), hydrofluorocarbons (e.g., CF3 H), fluorinated sulfur (e.g., SF6), fluorinated nitrogen (e.g., NF3), fluorochemicals such as, e.g., CF3 OCF3 and fluorochemicals available under the trade designation Fluorinert such as, e.g., Fluorinert FC-43 (commercially available from Minnesota Mining and Manufacturing Company, Minnesota), and combinations thereof.

In some embodiments, the atmosphere of fluorine containing species can also include an inert diluent gas such as, e.g., helium, argon, nitrogen, and combinations thereof.

In some embodiments, the electrical discharge applied during the fluorination process is capable of modifying the surface chemistry of the polymeric article when applied in the presence of a source of fluorine containing species. The electrical discharge is in the form of plasma, e.g., glow discharge plasma, corona plasma, silent discharge plasma (also referred to as dielectric barrier discharge plasma and alternating current (“AC”) corona discharge), and hybrid plasma, e.g., glow discharge plasma at atmospheric pressure, and pseudo glow discharge. Preferably the plasma is an AC corona discharge plasma at atmospheric pressure. Examples of useful surface modifying electrical discharge processes are described in, for example, U.S. Pat.. Nos. 5,244,780, 4,828,871, and 4,844,979, all of which are incorporated herein in their entirety.

Another fluorination process includes immersing a polymeric article into a liquid that is inert with respect to elemental fluorine, and bubbling elemental fluorine gas through the liquid to produce a surface fluorinated article. Examples of useful liquids that are inert with respect to fluorine include perhalogenated liquids, e.g., perfluorinated liquids such as Performance Fluid PF 5052 (commercially available from Minnesota Mining and Manufacturing Company). The elemental fluorine containing gas that is bubbled through the liquid can include an inert gas such as, e.g., nitrogen, argon, helium, and combinations thereof.

In some embodiments, charging the polymeric article to produce an electret can be accomplished using a variety of techniques, including, e.g., hydrocharging, i.e., contacting an article with water in a manner sufficient to impart a charge to the article, followed by drying the article, and/or DC corona charging. The charging process can be applied to one or more surfaces of the article.

One example of a useful hydrocharging process includes impinging jets of water or a stream of water droplets onto the article at a pressure and for a period sufficient to impart a filtration enhancing electret charge to the web, and then drying the article. The pressure necessary to optimize the filtration enhancing electret charge imparted to the article will vary depending on the type of sprayer used, the type of polymer from which the article is formed, the type and concentration of additives to the polymer, and the thickness and density of the article. Pressures in the range of about 10 to about 500 psi (69 to 3450 kPa) are suitable. An example of a suitable method of hydrocharging is described in U.S. Pat. No. 5,496,507 (Angadjivand et al.). The jets of water or stream of water droplets can be provided by any suitable spray device. One example of a useful spray device is the apparatus used for hydraulically entangling fibers. Examples of suitable DC corona discharge processes are described in U.S. Pat. No. 30,782 (van Turnhout), U.S. Pat. No. 31,285 (van Turnhout), U.S. Pat. No. 32,171 (van Turnhout), U.S. Pat. No. 4,375,718 (Wadsworth et al.), U.S. Pat. No. 5,401,446 (Wadsworth et al.), U.S. Pat. No. 4,588,537 (Klasse et al.), and U.S. Pat. No. 4,592,815 (Nakao).

In some embodiments, the electret layer has a thickness of between about 0.5 mm and about 2 mm.

In some embodiments, the electret layer is a meltblown web, such as, for example, those described in U.S. Pat. Nos. 6,858,297, or 7,858,163, both of which are incorporated by reference in their entirety herein. Meltblown microfibers can be prepared as described in Wente, Van A., “Superfine Thermoplastic Fibers,” Industrial Eng. Chemistry, Vol. 48, pp. 1342-1346 and in Report No. 4364 of the Naval Research laboratories, published May 25, 1954, entitled, “Manufacture of Super Fine Organic Fibers,” by Wente et al. Meltblown microfibers preferably have an effective fiber diameter in the range of less than 1 to 50 μm as calculated according to the method set forth in Davies, C. N., “The Separation of Airborne Dust and Particles,” Institution of Mechanical Engineers, London, Proceedings 1B, 1952.

In some embodiments, the electret layer may be a spunbond web. In some embodiments, the spunbond web may be relatively stiff, e.g., so as to exhibit a Gurley Stiffness of at least about 200, 300, 400, 500, 700, 800, 900, or 1000 mg. The presence of such a high-stiffness layer can help ensure that air filter media is pleatable. A spunbond web may be made by methods well known to those of skill in the art, e.g., the methods disclosed in U.S. Pat. No. 7,947,142 to Fox, which is incorporated by reference herein in its entirety. The skilled person will appreciate that the individual fibers and/or the arrangement of fibers in a spunbond web, will distinguish the spunbond web from other types of webs (e.g., from meltblown webs, carded webs, airlaid webs, wetlaid webs, and so on). In other words, a spunbond web will be readily recognizable, and distinguishable from other types of nonwoven webs, to the skilled person, based on the arrangement of fibers in the web. By way of one particular example, a spunbond web will be comprised of fibers that are essentially continuous, as opposed to discrete length staple fibers.

Where present, the spunbond web may be made of any suitable fiber-forming polymer, e.g., chosen from polyolefins, polyesters, nylons, and so on. In one embodiment, the spunbond web may be formed of polypropylene. In some embodiments, the spunbond web may exhibit a basis weight of at least about 60, 80, 100, or 120 g/m². In some embodiments, the spunbond web may exhibit a basis weight of at most about 200, 180, 160, 140, 120, or 100 g/m². In some embodiments, the spunbond web may exhibit a solidity (measured according to the procedures outlined in U.S. Pat. No. 8,162,153 to Fox) of greater than about 8.0, 9.0, 10.0, 11.0, or 12.0%. In some embodiments, the fibers of the first nonwoven web may exhibit a fiber diameter of at least about 10, 20, 30, or 40 microns. In some embodiments, the spunbond web may exhibit an airflow resistance (i.e., pressure drop, measured according to the procedures outlined in U.S. Pat. No. 8,162,153 to Fox) of less than about 1.0, 0.8, 0.6, or 0.4 mm of water (at a face velocity of 14 cm/s).

### The Sorbent Layer

The sorbent particles that can be used in the sorbent layer include at least some particles that can capture formaldehyde. In particular embodiments, the sorbent particles include at least some activated carbon. In specific embodiments, the sorbent particles include at least some treated activated carbon, which is defined here as meaning any activated carbon that has been treated to enhance its ability to capture formaldehyde. Suitable treatments may, e.g., provide the activated carbon with at least some amine functionality and/or at least some manganate functionality and/or at least some iodide functionality. Specific examples of treated activated carbons that may be suitable include those that have been treated with, e.g., potassium permanganate, urea, urea/phosphoric acid, and/or potassium iodide. (Any desired combination of such treatments may be used.) Other sorbent particles that may be potentially suitable, e.g., for removing formaldehyde include, e.g., treated zeolites and treated activated alumina. Such particles may be included, e.g., along with treated activated carbon if desired. For example, some embodiments may include those described in U.S. Patent Application No. 62/307831 entitled Air Filters Comprising Polymeric Sorbents for Aldehydes, the entirety of which is incorporated by reference herein.

The sorbent particles may be provided in any usable form including beads, flakes, granules or agglomerates. Other sorbent particles may also be present in addition to activated carbon, for any desired purpose. Other such ancillary sorbents include, e.g., alumina and other metal oxides; sodium bicarbonate; metal particles (e.g., silver particles) catalytic agents such as hopcalite (which can catalyze the oxidation of carbon monoxide); nanoscale gold, which may catalyze the oxidation of carbon monoxide or formaldehyde; clay and other minerals treated with acidic solutions such as acetic acid or alkaline solutions such as aqueous sodium hydroxide; ion exchange resins; molecular sieves and other zeolites;

silica; biocides; fungicides and virucides, and so on. However, in some embodiments, the sorbent particles consist essentially of activated carbon, e.g., treated activated carbon.

The sorbent (e.g., activated carbon) particle size may vary as desired. In some embodiments, the sorbent particles may have a standard U.S. mesh size (grade) of at least about 16 mesh ((i.e., particle size nominally less than 1190 micrometers), at least about 20 mesh (<840 micrometers), at least about 40 mesh (<425 micrometers), at least about 60 mesh (<250 micrometers), or at least about 100 mesh (<149 micrometers). In some embodiments, the sorbent particles may have a standard U.S. mesh size of no greater than about 325 mesh (i.e., particle size nominally greater than 44 micrometers), 140 mesh (>105 micrometers), 100 mesh (>150 micrometers), 80 mesh (>180 micrometers), 60 mesh (>250 micrometers), 50 mesh (>300 micrometers), or 45 mesh (>355 micrometers).

The skilled person will understand that these mesh sizes correspond to nominal grades rather than absolute standards; for example, if a material is described as a 12 mesh material, then approximately 95% or more of the particles will pass through a 12-mesh sieve (and will thus be nominally smaller than about 1680 micrometers in size). If a material is described as 12×20 mesh, then 95% or more of the material will pass through a 12-mesh sieve (i.e., particles smaller than about 1680 micrometers will pass through a 12-mesh sieve) and be retained by a 20-mesh sieve (i.e., particles larger than about 841 micrometers will not pass through a 20-mesh sieve). Suitable sorbent particle size grades may include, e.g., 16×32, 20×40, 25×45, 32×60, 48×100, 40'140, and 80×325 mesh sized granular activated carbons, or any other grade falling within this 16×325 mesh range. Mixtures (e.g., bimodal mixtures) of sorbent particles having different size ranges may be employed if desired. Suitable sorbents, e.g., various treated activated carbons, may be obtained, e.g., from Calgon Corporation, Molecular Products, KOWA, Jacobi, Kuraray, and Oxbow Activated Carbon.

In some embodiments, the sorbent layer may exhibit a basis weight of about 100 g/m² to about 625 g/m². In various embodiments, the sorbent layer may exhibit a basis weight of sorbent particles of at least about 100 g/m², at least about 150 g/m², at least about 200 g/m², or at least about 300 g/m². In various embodiments, sorbent particles may make up at least about 80, 85, or 90 wt. % of the total materials of the sorbent layer.

The sorbent layer can be of the type, include the materials described in, and/or be made using the processes described in U.S. Pat. No. 6,397,458 and/or U.S. Patent Publication No. 2012/272829, each of which is incorporated by reference in its entirety.

### The Backing Layer

The backing layer is optional. Embodiments not including a backing layer can, for example, include an electret or sorbent layer having sufficient stiffness to permit the multilayer construction to be pleated.

Where present, the backing layer may include any suitable nonwoven web to provide sufficient stiffness to permit the multilayer construction to be pleated. In some embodiments, the backing layer is relatively stiff, e.g., so as to exhibit a Gurley Stiffness of at least about 200, 300, 400, 500, 700, 800, 900, or 1000 mg. The presence of such a high-stiffness layer can help ensure that the air filter media is pleatable. Suitable first nonwoven webs may include, e.g., airlaid webs, wetlaid webs, carded webs, and so on. In some embodiments, the backing layer is a spunbond web. A spunbond web may be made by methods well known to those of skill in the art, e.g., the methods disclosed in U.S. Pat. No. 7,947,142 to Fox, which is incorporated by reference herein in its entirety. The skilled person will appreciate that the individual fibers and/or the arrangement of fibers in a spunbond web will distinguish the spunbond web from other types of webs (e.g., from meltblown webs, carded webs, airlaid webs, wetlaid webs, and so on). In other words, a spunbond web will be readily recognizable, and distinguishable from other types of nonwoven webs, to the skilled person, based on the arrangement of fibers in the web. (By way of one particular example, a spunbond web will be comprised of fibers that are essentially continuous, as opposed to, e.g., the below-described staple fibers.)

In some embodiments, the backing layer a staple-fiber web. The skilled person will recognize that staple fibers are fibers that have been pre-made and have then been cut to a predetermined length (and have been assembled into a web, e.g., by airlaying, carding, wet-laying, or the like). In some embodiments, the backing layer may be chosen from the group consisting of a spunbond web and a staple-fiber web.

The backing layer may be made of any suitable fiber-forming polymer, e.g., chosen from polyolefins, polyesters, nylons, and so on. In one embodiment, the backing layer may be formed of polypropylene. In various embodiments, the backing layer may exhibit a basis weight of at least about 60, 80, 100, or 120 g/m². In some embodiments, the backing layer may exhibit a basis weight of at most about 200, 180, 160, 140, 120, or 100 g/m². In some embodiments, the backing layer may exhibit a solidity (measured according to the procedures outlined in U.S. Pat. No. 8,162,153 to Fox) of greater than about 8.0, 9.0, 10.0, 11.0, or 12.0%. In some embodiments, the fibers of the backing layer may exhibit a fiber diameter of at least about 10, 20, 30, or 40 microns. In some embodiments, the backing layer may exhibit an airflow resistance (i.e., pressure drop, measured according to the procedures outlined in U.S. Pat. No. 8,162,153 to Fox) of less than about 1.0, 0.8, 0.6, or 0.4 mm of water (at a face velocity of 14 cm/s).

In some embodiments, the backing layer may be essentially free of charged fibers. In other words, in such embodiments the first nonwoven web will not include any electrets (which will be well known to the skilled person as quasi-permanent electric charges whose presence can be straightforwardly identified). In such cases the backing layer may serve mainly only to stiffen the air filter media (that is, it may perform little or no filtering of fine particles, although it may of course block or capture, e.g., some very large particles of dirt or debris).

In other embodiments, the backing layer may include electrostatically charged fibers. In such embodiments, the backing layer may serve, e.g., to filter fine particles in addition to providing a stiffening function. If the first nonwoven web of the first, stiffening layer is to be charged, this may be done by any suitable method, for example, by imparting electric charge to the nonwoven web using water as taught in U.S. Pat. No. 5,496,507 to Angadjivand, or as taught in U.S. Pat. No. 7,765,698 to Sebastian. Nonwoven electret webs may also be produced by corona charging as described in U.S. Pat. No. 4,588,537 to Klaase, or using mechanical approaches to impart an electric charge to fibers as described in U.S. Pat. No. 4,798,850 to Brown. Any combination of such approaches may be used. The backing layer may be charged before being incorporated into the air filter media; or, after air filter media is formed. In any case, any such charging may be conveniently performed before the air filter media is pleated. In various embodiments, the backing layer (e.g., if charged) may exhibit a % Penetration (using Dioctyl Phthalate as a challenge material, and tested using methods described in U.S. Pat. No. 7,947,142 to Fox) of less than about 50, 40, 30, 20, 10, or 5%. In alternative embodiments, the backing layer (e.g., if not charged) may exhibit a % Penetration of greater than about 80, 90, or 95%.

Some embodiments of the present disclosure relate to room air purifiers including any of the embodiments of filtration media described herein. In some embodiments, the room air purifiers have a particle CCM of P4 per the China National Standard. In some embodiments, the room air purifiers have a particle CCM of P4 per the China National Standard with less than 1.5 m² of filtration media. In some embodiments, the room air purifiers have a particle CCM of P4 per the China National Standard with less than 1.2 m² of filtration media. In some embodiments, the room air purifiers have a formaldehyde CCM of F4 (1500 mg) per the China National Standard.

It is apparent to those skilled in the art that more media typically gives a greater CCM for pollutants such as particulate and formaldehyde. However, high performing combination media which can capture both particulate and gaseous pollutants are expensive, so there is a disincentive to use more media in the filter. Advantageously, the filtration media and filters of the current disclosure are capable of providing a room air purifier filter with less than one square meter of nominal media usage and still have a particle CCM of at least P4 (12000 mg) per the China National Standard, reducing cost and making this important product available to more people seeking cleaner air.

The following examples describe some exemplary constructions of various embodiments of the retroreflective articles and methods of making the retroreflective articles described in the present application. The following examples describe some exemplary constructions and methods of constructing various embodiments within the scope of the present application. The following examples are intended to be illustrative, but are not intended to limit the scope of the present application.

### EXAMPLES

Media CCM Test: A set of experiments were undertaken to understand and compare the area-based cigarette smoke loading performance using methods to mimic the full-filter/device GB/T 18801-2015 test. In the media experiments, 5.25 inch (133 mm) diameter circles of media were prepared and placed in a holder which left a 4.5 inch (114 mm) diameter circle exposed. The holder was placed inside a recirculating air chamber. Sections of Camel brand cigarettes (typically ¼ or ½ cigarette at a time, and which had their filters removed) were burned inside the chamber while a recirculating fan was operating and which pulled the smoke-laden air through the filter media samples (one per chamber). The fan was run continuously until the smoke was fully removed from the chamber. The efficiency of the filter media was monitored at various steps of the cigarette smoke loading process, including the clean filter media, by testing the single-pass efficiency on a TSI 8130 Automated Filter Tester using a NaCl aerosol at 85 liters per minute, for a face velocity of 14 cm/s (the airflow resistance of the media was also measured during these tests). The equation

$$QF = \frac{- ln ( \frac{\% Particle Penetration}{100} )}{Δ P}$$

was used to calculate QF. Units of QF are inverse pressure drop (reported in 1/mm H₂O).

A second order polynomial regression equation was applied to the cigarette quantity versus efficiency data to determine the point at which the starting efficiency had dropped by 50%, consistent with the general approach of the GB/T particle CCM test. The output of this test is referred to as the Media CCM* Test, and was normalized to filter media area.

### Comparative Examples

A series of commercially available media were obtained and tested alongside filtration media of the present disclosure. Comparative Examples 1-6 are the following commercially available filtration media: CE1: 40 GSM (also sometimes referred to as “MERV 18”) made and sold by 3M Company; CE2: 40C made and sold by 3M Company; CE3: M18/G380 made and sold by Azure Wind; CE4: FY2426 made and sold by Philips; CES: FY2428 made and sold by Philips; and CE6: CFX-D150SC made and sold by Samsung.

### Example 1

A three-layer air filter media was formed using a procedure that was generally similar to that described in Example 1 of US Patent Application Publication No. 2012/272829 to Fox. A spunbond polypropylene web obtained from Fiberweb under the trade designation Typar 3251, with a basis weight of 87 g/m2 and an airflow resistance of 0.41 mm of water and was placed on a moving collector (belt) surface. The collector surface with the first nonwoven web atop, was passed perpendicular to a meltblowing apparatus so that a commingled stream of (incipient) fibers and activated carbon particles was deposited atop the first nonwoven web. The fibers were made from a molten extrudate comprised of a thermoplastic elastomer obtained from Dow under the trade designation Versify 4301; the activated carbon was a 32×60 mesh, treated activated carbon. The composition of the combined sorbent and fibers was approximately 12 wt % fibers and approximately 88 wt % activated carbon. The meltblown fibers formed a meltblown web. The meltblown fibers bonded sufficiently to the activated carbon (and to each other) to form the sorbent layer (which layer was bonded to the first, stiffening layer provided by the first nonwoven).

A nonwoven was formed as follows: A polypropylene meltblown web was prepared with a weight of 57 g/m² and a thickness of 0.85 mm, as described in Wente, Van A., “Superfine Thermoplastic Fibers,” Industrial Eng. Chemistry, Vol. 48, pp. 1342-1346. The meltblown web was subjected to a fluorination treatment on both sides as described in Example 1 of U.S. Pat. No. 7,887,889 (incorporated herein in its entirety) with power density (W/cm²) of 0.13 W/cm², plasma treatment time of 0.28 min, and pressure of 500 mtorr. Following fluorination, the fluorinated meltblown web was hydrocharged according to the methods described in U.S. Pat. No. 5,496,507 to Angadjivand, incorporated herein in its entirety. After fluorination and hydrocharging, the web exhibited a pressure drop of 4.7 mm H₂O and an efficiency of 99.1%. The resulting nonwoven layer was brought into contact with the exposed surface of the sorbent layer. Under these conditions the nonwoven was mildly bonded to the sorbent layer, so as to provide a three-layer air filter media.

The resulting three-layer air filter media had a basis weight of 492 g/m², an airflow resistance of 5.3 mm of water, a thickness of 2.4 mm, and a total sorbent content (basis weight) of 299 g/m².

### Example 2

A three-layer air filter media was formed using a procedure that was analogous to Example 1. The key differences are summarized as follows. The polypropylene meltblown web was prepared with a weight of 57 g/m² and a thickness of 0.98 mm. After fluorination and hydrocharging, the web exhibited a pressure drop of 4.9 mm H₂O and an efficiency of 99.4%. The resulting three-layer air filter media had a basis weight of 480 g/m², an airflow resistance of 5.4 mm of water, a thickness of 2.5 mm, and a total sorbent content (basis weight) of 294 g/m².

The webs from each of Example 1 and Example 2 were pleated using a folding-blade style pleater with a pleat height of 48 mm and a pleat spacing of 10.5 mm. The pleating apparatus was held at approximately 70-75° C. Under these conditions, the media did not require the lamination of any supporting material to the media (before pleating) to be co-pleated along therewith, in order to successfully form and hold the pleated shape. After the pleating process was performed, three linear strips of molten hot melt adhesive were attached to the pleat tips of both major surfaces of the pleated media so as to maintain consistent pleat spacing. The pleated filter was also formed into a framed filter 431×290 mm in size. A cardboard perimeter frame was used, wherein the frame overlapped the filter face approximately 12 mm.

### Example 3

A three-layer air filter media was formed using a procedure that was analogous to Example 1, except that the web was compressed as the fluorinated web was brought into contact with the sorbent layer. The key differences are summarized as follows. The polypropylene meltblown web was prepared with a weight of 57 g/m² and a thickness of 0.90 mm. After fluorination and hydrocharging, the web exhibited a pressure drop of 5 mm H₂O and an efficiency of 99.32%. The resulting three-layer air filter media had a basis weight of 478 g/m², an airflow resistance of 7.1 mm of water, a thickness of 2.0 mm, and a total sorbent content (basis weight) of 293 g/m².

The web was pleated using a folding-blade style pleater with a pleat height of 48 mm and a pleat spacing of 10.9 mm. The pleating apparatus was held at approximately 70-75° C. Under these conditions, the media did not require the lamination of any supporting material to the media (before pleating) to be co-pleated along therewith, in order to successfully form and hold the pleated shape. After the pleating process was performed, three lines of molten hot melt adhesive were applied to the pleat tips of both major surfaces of the pleated media so as to maintain consistent pleat spacing. The pleated filter was also formed into a framed filter 426×285 mm in size. A cardboard perimeter frame was used, wherein the frame overlapped the filter face approximately 12 mm.

### Example 4

The same filter construction and media lot of Example 3 were tested in a commercially available room air purifier, model KJ455F, sold by 3M China, Ltd. (Shanghai, China).

TABLE 1
Cigarette Loading Data

| | | | Initial | | Media |
|---|---|---|---|---|---|
| | | Initial | Resistance | | CCM Test |
| | Type | Efficiency | (mm H₂O) | QF | # Cig/m² |
| CE1 | Meltblown | 99.7% | 6.2 | 0.92 | 188 |
| CE2 | Meltblown | 99.98% | 11.3 | 0.76 | 375 |
| CE3 | Carbon-loaded | 99.8% | 8.0 | 0.80 | 236 |
| | web with 3M | | | | |
| | 40GSM | | | | |
| CE4 | Carbon-loaded | 96.9% | 8.5 | 0.41 | 137 |
| | web with | | | | |
| | meltblown layer | | | | |
| CE5 | Carbon-loaded | 96.4% | 8.7 | 0.38 | 109 |
| | web with | | | | |
| | meltblown layer | | | | |
| CE6 | Carbon-loaded | 99.8% | 12.6 | 0.50 | 267 |
| | web with | | | | |
| | meltblown layer | | | | |
| Ex. 1 | Carbon-loaded | 99.8% | 5.3 | 1.21 | 821 |
| | web with | | | | |
| | fluorinated | | | | |
| | meltblown layer | | | | |
| | of the present | | | | |
| | disclosure | | | | |
| Ex. 2 | Carbon-loaded | 99.6% | 5.4 | 1.06 | 734 |
| | web with | | | | |
| | fluorinated | | | | |
| | meltblown layer | | | | |
| | of the present | | | | |
| | disclosure | | | | |
| Ex. 3/4 | Carbon-loaded | 99.2% | 6.4 | 0.75 | 644 |
| | web with | | | | |
| | fluorinated | | | | |
| | meltblown layer | | | | |
| | of the present | | | | |
| | disclosure | | | | |

Results from the Media CCM* test are presented in Table 1. Several exemplary conclusions can be drawn from the above data. First, it holds generally true that increasing filter pressure drop results in an increased Media CCM (e.g., CE2 versus CE1). Without being bound by theory, this is believed to be due to the greater mechanical filtration surface area imparted by the finer fibers and/or greater area weight which causes the higher pressure drop. Second, most of the competitive carbon-loaded media (CE3-CE6) have a poor balance of Media CCM* to pressure drop—at least partly because the added pressure of the sorbent and additional adhesive adds to the pressure but not significantly to the CCM. Finally, the multilayer filtration media of the present disclosure outperforms all of the other competitive combination media—with both lower pressure drop and also greatly higher Media CCM.

Several full room air purifier and filter particle CCM (P-CCM) tests were carried out according to GB/T 18801-2015. Several of the same samples described above were tested. For Example 4, the CCM test was completed, on behalf of the present inventors, at the Vkan Certification & Testing Co. Ltd. in Guangzhou, China. Table 2 lists the filter size to the outside dimensions of the rigid frame (i.e., neglecting any foam which might be present). The nominal media area is also calculated—using the maximum dimensions of the filter, according to the equation below:

Nominal media area=(Outer width)×(Outer length)×(Outer height)×2÷(Average pleat spacing)

It is understood that the true media area is likely several % less as the pleats do not fill the entire dimension in the length, width, or height due to frame thickness, etc. The filter pressure was tested in a filter test duct at the airflow test velocity specified in Table 2; the test velocity was calculated based upon the outside frame dimensions of the filter and the actual airflow test volume.

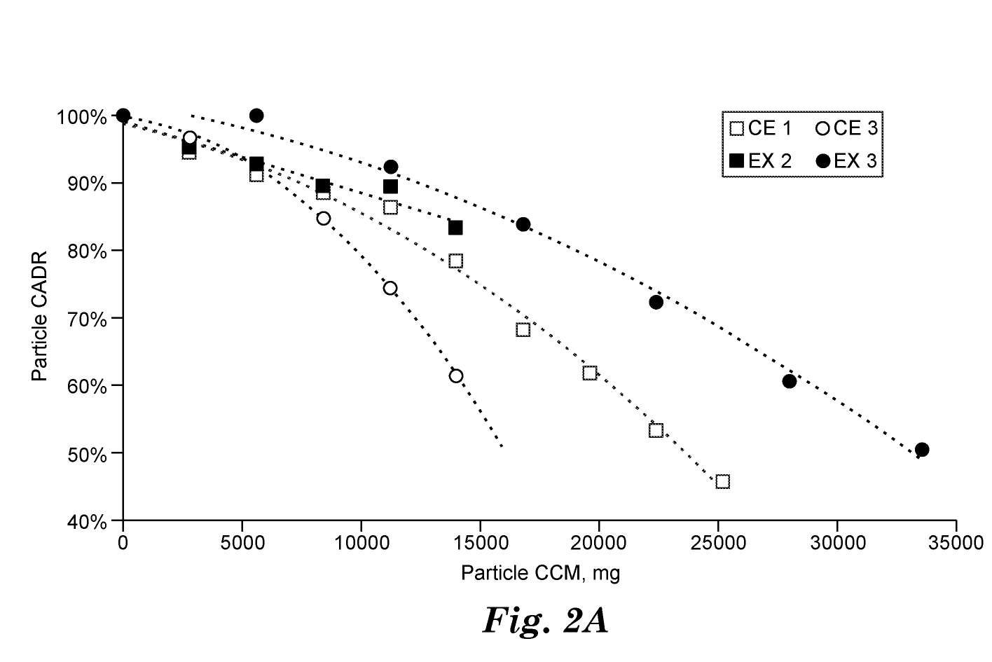

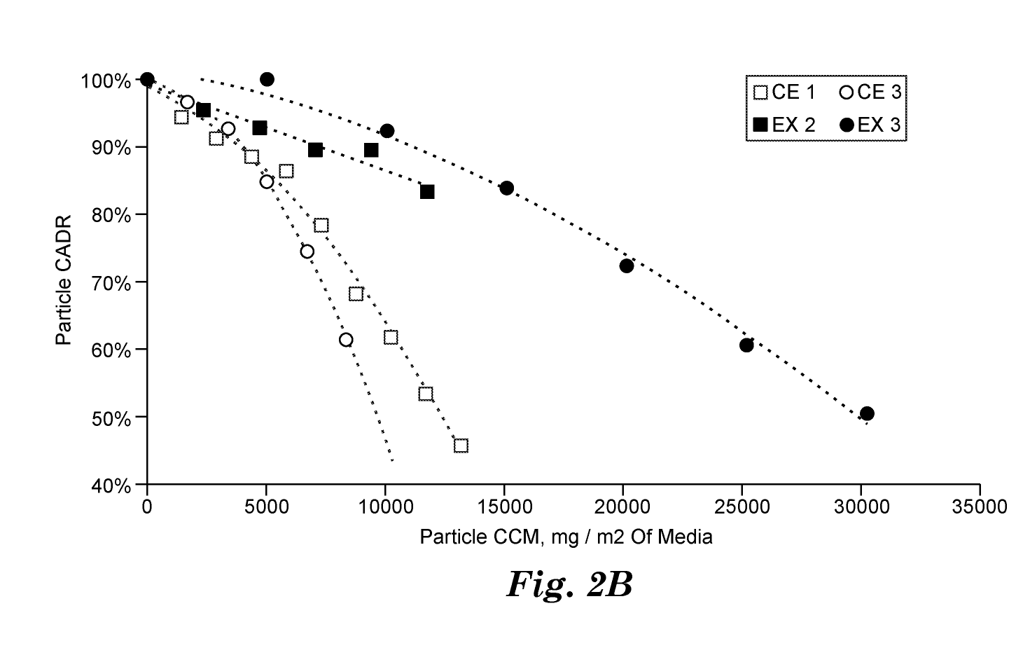

The Comparative Examples were carried out to approximately 50% reduction of the initial CADR; the final CCM was determined using a second-order polynomial best fit line, as is shown in FIG. 2, except for Example 4 where the exact CCM is listed. Example 2 was not carried out significantly past the P4 minimum requirement of 12,000 mg; because the data is often non-linear (e.g., both CE1 and CE3 show non-linearity), Example 2 was not extrapolated to 50% reduction of CADR. Example 3 was carried out to the full 50% reduction of CADR, and the final CCM was determined using a second-order polynomial best fit line.

TABLE 2
Full filter P-CCM test results

| | | | | | | | Initial | | | Filter | |
|---|---|---|---|---|---|---|---|---|---|---|---|
| | | Filter | Filter | Filter | Pleat | Nominal | particle | Particle | Particle | test | Filter |
| | RAP | L, | W, | H, | spacing, | Media | CADR, | CCM, | CCM, | velocity, | pressure, |
| Name | Machine | mm | mm | mm | mm | area, m² | m³/hr | mg | mg/m² | m/s | Pa |
| CE1 | KJEA418 | 415 | 338 | 30 | 4.4 | 1.91 | 418 | 23600 | 12338 | 0.87 | 56.8 |
| CE3 | Prototype | 431 | 290 | 50 | 7.5 | 1.67 | 458 | 16115 | 9670 | 1.06 | 81.8 |
| Example 2 | Prototype | 431 | 290 | 50 | 10.5 | 1.19 | 470 | >>14000 | >>12000 | 1.06 | 77.1 |
| Example 3 | Prototype | 426 | 285 | 50 | 10.9 | 1.11 | 476 | 33180 | 27988 | 1.06 | 71.3 |
| Example 4 | KJ455F | 426 | 285 | 50 | 10.9 | 1.11 | 454 | 40502 | 36488 | 1.06 | 71.3 |

FIGS. 2A and 2B visually depict the particle CCM test results and performance. FIG. 2A is typical of a loading curve for a CCM test; the initial CADR is normalized to 100%, and as particulate matter is accumulated on the filter (particulate matter from burning cigarettes), the CADR decreases. For many high efficiency media types, this CADR decay curve takes on a second-order polynomial shape. When the initial CADR has decayed to 50%, based on a data fit, the total CCM in milligrams is estimated and reported. The minimum CCM to reach the top rating, P4, is 12,000 mg.

In FIG. 2A, each of the four filters reaches the P4 level. It is clear that Examples 2, 3, and 4 have significantly better CCM performance than the Comparative Examples.

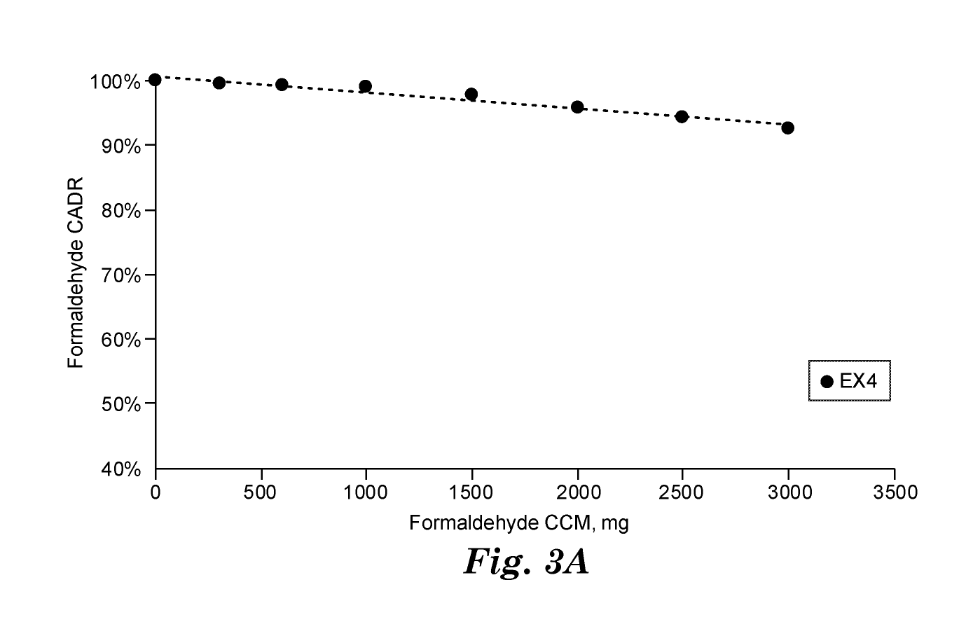

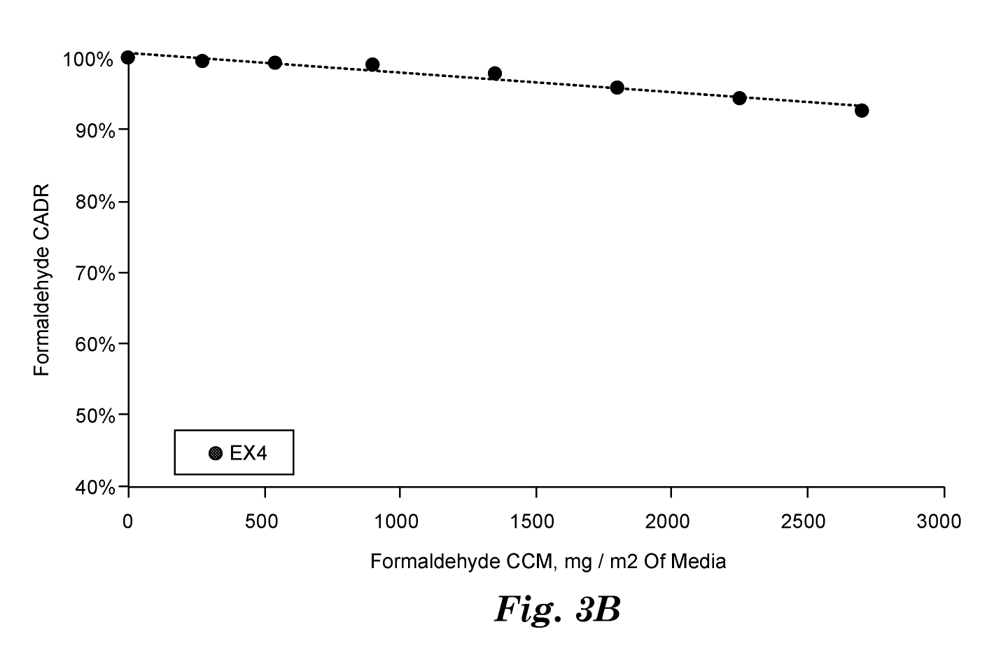

A full room air purifier and filter formaldehyde CCM test (F-CCM) was carried out on Example 4 according to GB/T 18801-2015. The full formaldehyde CCM test was completed, on behalf of the present inventors, at the Guangzhou Testing Center of Industrial Microbiology in Guangzhou, China. The results are presented in Table 3 and FIGS. 3A and 3B. FIG. 3A is typical of a loading curve for a F-CCM test; the initial CADR is normalized to 100%, and as formaldehyde is accumulated on the filter, the CADR decreases. When the initial CADR has decayed to 50% of the starting value, the total CCM in milligrams is estimated and reported. The minimum formaldehyde CCM to reach the top rating, F4, is 1500 mg. The test of Example 4 was carried out to 2× the minimum F4 requirement, and the test results indicate that the filter achieved the top rating of F4. Even after capturing 3000 mg of formaldehyde, the formaldehyde CADR was still at 92.7% of the initial formaldehyde CADR, indicating that the formaldehyde CCM at the final 50% reduction of the initial CADR likely greatly exceeded 3000 mg.

TABLE 3
Full filter Formaldehyde CCM test results

| | | Filter | Filter | Filter | Pleat | Nominal | Initial | | |
|---|---|---|---|---|---|---|---|---|---|
| | RAP | L, | W, | H, | spacing, | Media | formaldehyde | Formaldehyde | Formaldehyde |
| Name | Machine | mm | mm | mm | mm | area, m² | CADR, m³/hr | CCM, mg | CCM, mg/m² |
| Example 4 | KJ455F | 426 | 285 | 50 | 10.9 | 1.11 | 266 | >3000 | >2700 |

### Embodiments

1. A multilayer filtration media, comprising: a fluorinated electret layer; a sorbent layer adjacent to the fluorinated electret layer; and an optional backing layer having a Gurley stiffness of at least about 200 mg; wherein the filter media is pleated; and where the backing layer is not present, at least one of the fluorinated electret layer, the sorbent layer, or the combination of the two layers has a Gurley stiffness of at least about 200 mg.

2. The multilayer filtration media of embodiment 1, further comprising: a backing layer adjacent to the sorbent layer, wherein the backing layer has a Gurley stiffness of at least about 200 mg.

3. The multilayer filtration media of embodiment 2, wherein the backing layer is an meltspun web or a staple-fiber web.

4. The multilayer filtration media of embodiment 2 or 3, wherein the backing layer includes one or more polyolefins, polyesters, and/or nylons.

5. The multilayer filtration media of any of the preceding embodiments, wherein the multilayer filtration media has a pressure drop of less than 15 mm H₂O at 14 cm/s test velocity.

6. The multilayer filtration media of any of the preceding embodiments, wherein a pleated filter formed from the multilayer filtration media has a pressure drop of less than 150 Pa at a nominal face velocity of 1.1 m/s.

7. The multilayer filtration media of any of the preceding embodiments, wherein a pleated filter formed from the multilayer filtration media has a particle CCM of greater than 12,000 mg when tested according to GB/T 18801-2015.

8. The multilayer filtration media of any of the preceding embodiments, wherein a pleated filter formed from the multilayer filtration media has a particle CCM of greater than 12,000 mg/m² of nominal filter media when tested according to GB/T 18801-2015 and the CCM is normalized to the nominal filter media area.

9. The multilayer filtration media of any of the preceding embodiments, wherein the multilayer filtration media has a particle CCM of greater than 300 cigarettes per square meter when tested according to the Media CCM Test.

10. The multilayer filtration media of any of the preceding embodiments, wherein the multilayer filtration media has an initial particle efficiency of greater than 90%.

11. The multilayer filtration media of any of the preceding embodiments, wherein the sorbent layer has about 100-500 grams of sorbent.

12. The multilayer filtration media of any of the preceding embodiments, wherein the sorbent layer includes sorbent having a US mesh size range of 20 to 320.

13. The multilayer filtration media of any of the preceding embodiments, wherein the sorbent layer includes activated carbon.

14. The multilayer filtration media of any of the preceding embodiments, wherein the sorbent layer includes one or more chemically impregnated sorbents that provide formaldehyde removal.

15. The multilayer filtration media of any of the preceding embodiments, wherein the sorbent layer includes one or more sorbents reactive to formaldehyde.

16. The multilayer filtration media of any of the preceding embodiments, wherein the sorbent layer includes substantially continuous adhesive fibers that are bonded to the surface of sorbent particles.

17. The multilayer filtration media of any of the preceding embodiments, wherein the sorbent layer includes alternating layers or adhesive and sorbent.

18. The multilayer filtration media of any of the preceding embodiments, wherein the sorbent layer includes more than one layer of sorbent.

19. The multilayer filtration media of any of the preceding embodiments, wherein the sorbent layer includes more than one type of sorbent.

20. The multilayer filtration media of any of the preceding embodiments, wherein the fluorinated electret layer is a meltblown web or a meltspun web.

21. A room air purifier including the filtration media of any of embodiments 1-20.

22. The room air purifier of embodiment 21, wherein the room air purifier exhibits a particle CCM of P4 per the China National Standard.

23. The room air purifier of embodiment 21 or 22, wherein the room air purifier exhibits a particle CCM of P4 per the China National Standard with less than 1.5 m² of filtration media.

24. The room air purifier of embodiment 21 or 22, wherein the room air purifier exhibits a particle CCM of P4 per the China National Standard with less than 1.2 m² of filtration media.

25. The room air purifier of any of embodiments 21-24, wherein the room air purifier exhibits a formaldehyde CCM of F4 per the China National Standard.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention can be determined with reference to the appended claims, along with the full scope of equivalents to which such claims are entitled.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

What is claimed is:

1. A multilayer filtration media, comprising:
a fluorinated electret layer;
a sorbent layer adjacent to the fluorinated electret layer; and
an optional backing layer having a Gurley stiffness of at least about 200 mg;
wherein the filter media is pleated; and
where the backing layer is not present, at least one of the fluorinated electret layer, the sorbent layer, or the combination of the two layers has a Gurley stiffness of at least about 200 mg.

2. The multilayer filtration media of claim 1, further comprising:
a backing layer adjacent to the sorbent layer, wherein the backing layer has a Gurley stiffness of at least about 200 mg.

3. The multilayer filtration media of claim 2, wherein the backing layer is an meltspun web or a staple-fiber web.

4. The multilayer filtration media of claim 1, wherein the multilayer filtration media has a pressure drop of less than 15 mm H₂O at 14 cm/s test velocity.

5. The multilayer filtration media of claim 1, wherein a pleated filter formed from the multilayer filtration media has a pressure drop of less than 150 Pa at a nominal face velocity of 1.1 m/s.

6. The multilayer filtration media of claim 1, wherein a pleated filter formed from the multilayer filtration media has a particle CCM of greater than 12,000 mg when tested according to GB/T 18801-2015.

7. The multilayer filtration media of claim 1, a pleated filter formed from the multilayer filtration media has a particle CCM of greater than 12,000 mg/m² of nominal filter media when tested according to GB/T 18801-2015 and the CCM is normalized to the nominal filter media area.

8. The multilayer filtration media of claim 1, wherein the multilayer filtration media has a particle CCM of greater than 300 cigarettes per square meter when tested according to the Media CCM Test.

9. The multilayer filtration media of claim 1, wherein the multilayer filtration media has an initial particle efficiency of greater than 90%.

10. The multilayer filtration media of claim 1, wherein the sorbent layer has about 100-500 grams of sorbent.

11. The multilayer filtration media of claim 1, wherein the sorbent layer includes sorbent having a US mesh size range of 20 to 320.

12. The multilayer filtration media of claim 1, wherein the sorbent layer includes activated carbon.

13. The multilayer filtration media of claim 1, wherein the sorbent layer includes one or more chemically impregnated sorbents that provide formaldehyde removal.

14. The multilayer filtration media of claim 1, wherein the sorbent layer includes one or more sorbents reactive to formaldehyde.

15. The multilayer filtration media of claim 1, wherein the sorbent layer includes substantially continuous adhesive fibers that are bonded to the surface of sorbent particles.

16. The multilayer filtration media of claim 1, wherein the sorbent layer includes alternating layers or adhesive and sorbent.

17. The multilayer filtration media of claim 1, wherein the sorbent layer includes at least one of more than one layer of sorbent and more than one type of sorbent.

18. A room air purifier including the filtration media of claim 1.

19. (canceled)

20. The room air purifier of claim 18, wherein the room air purifier exhibits a particle CCM of P4 per the China National Standard with less than 1.2 m² of filtration media.

21. The room air purifier of claim 18, wherein the room air purifier exhibits a formaldehyde CCM of F4 per the China National Standard.
